(19) United States
(12) Patent Application Publication
(10) Pub. No.: US 2010/0079578 A1
(43) Pub. Date: Apr. 1, 2010

(54) Apparatus, method and computer program product for three-dimensional image processing

(76) Inventors: Isao Mihara, Tokyo (JP); Shunichi Numazaki, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/794,376

(22) PCT Filed: Mar. 16, 2007
(86) PCT No.: PCT/JP07/56123

§ 371 Date: Jun. 28, 2007

(30) Foreign Application Priority Data
Sep. 26, 2006 (JP) 2006-261357

(51) Int. Cl. H04N 13/00; H04N 13/04

(52) U.S. Cl. 348/43; 348/51; 348/E13.001; 348/E13.075

(57) ABSTRACT

An apparatus for processing a three-dimensional image includes a specified value acquiring unit that acquires characteristics of a stereoscopic display unit as specified parameters, the stereoscopic display unit displaying a multi-viewpoint image created by mapping each pixel position included in a plurality of viewpoint images according to the characteristics; an observation value acquiring unit that acquires observation parameters indicating observation values of a stereoscopic image displayed on the stereoscopic display unit; a calculating unit that calculates conversion information indicating inverse mapping of the mapping based on the specified parameters; an observation value converting unit that converts observation parameters into converted parameters of the same dimension as the viewpoint images based on the conversion information; and a control unit that controls image processing on a viewpoint image corresponding to each pixel position of the stereoscopic image with respect to each of the viewpoint images based on the converted parameters.

### TECHNICAL FIELD

The present invention relates an apparatus, a method and a computer program product for three-dimensional image processing that performs image processing on a stereoscopic image.

### BACKGROUND ART

A dual eye system and a multi eye system are known as a system of displaying a three-dimensional image for naked eyes. The both systems include a light control element arranged on the surface of the display screen, such as a lenticular sheet (array of troffer lens that has lens characteristics only for the horizontal direction) or a parallax barrier. These systems cause the observer to sense a stereoscopic image (image that can be sensed stereoscopically from one direction only) by separately presenting two-dimensional images with binocular parallax to right and left eyes. The dual eye system causes the observer to sense the stereoscopic image with two two-dimensional images only from a single viewpoint direction. By contrast, the multi eye system can cause the observer to sense the stereoscopic image for example, with four two-dimensional images from three viewpoint directions. In other words, the multi eye system can provide a discontinuous motion parallax (phenomenon of viewing an object moving in the direction opposite to the physical movement of the observer).

The Integral Photo Imaging (IP) system is known as a technology that can display a stereoscopic image with a more improved motion parallax according to M. G. Lippmann, “La Photographie Integrale”, Comptes Rendus Academie des Sciences, Vol. 146, pp. 446-451 (1908). According to the technology, a lens array, which is equivalent for pixels in a stereoscopic photograph, is prepared first. A film is placed at a focal length of the lens array from a subject, and then the subject is shot. The lens array used for shooting is placed on the film to reproduce an image of the subject. If the film has a sufficient resolution, the IP system is an ideal system that can reproduce a complete floating image without limiting observation points similarly to holography.

Moreover, recently used is the Integral Imaging (II) system that uses a flat panel display such as a liquid crystal display (LCD) instead of a film. According to the II system, images of a subject desired to form a stereoscopic image are required to be shot from a plurality of viewpoints (as many as parallaxes desired to be realized), and to be used to create an image that realizes the stereoscopic image (hereinafter, “multi-viewpoint image”). Each image that is shot by each of a plurality of cameras with respective different viewpoints (parallaxes) (for example, a camera array of cameras arranged in parallel as many as parallaxes desired to be realized), and each of computer graphic (CG) images that is rendered from each of a plurality of viewpoints are hereinafter referred to as “viewpoint image”. The multi-viewpoint image is created by using a plurality of such viewpoint images (hereinafter, “viewpoint image group”), and by mapping the position of each pixel included in the viewpoint images (hereinafter, “pixel position”) onto one image based on a certain rule.

To create a multi-viewpoint image from viewpoint image group, the position of each of pixels included in each of the viewpoint images has to be rearranged into a certain arrangement sub-pixel by sub-pixel, in accordance with characteristics of a three-dimensional image display device. The reason for this is because according to the II system, similarly to the IP system, light of the multi-viewpoint image is reproduced through a lens array such as a lenticular sheet, so that pixel positions for displaying a stereoscopic image are determined in accordance with optical characteristics of the lens array. In addition, to realize a number of parallaxes on a flat panel display, a color filter configuration different from a normal color filter configuration can be used, for example, according to JP-A 2006-98779 (KOKAI). In such case, each position of the pixels in a multi-viewpoint image is to be determined sub-pixel by sub-pixel in accordance with characteristics of the color filter.

In some cases, image processing, such as noise reduction and blending, can be performed on a displayed stereoscopic image. In such image processing, each of viewpoint images relevant to the stereoscopic image is processed according to a certain image processing.

However, to create the multi-viewpoint image as described above, pixels included in each of the viewpoint image have to be rearranged based on the characteristics of the lens array and the color filter relevant to the three-dimensional display device. According to the conventional technology as described above, the rearrangement of the pixels is not considered, and the image processing is simply performed on each of the viewpoint images, which does not mean an appropriate image processing, thereby possibly causing degradation of the quality of the displayed stereoscopic image.

A case where the quality of a stereoscopic image is degraded by image processing is explained below with reference to an example of image processing that intends to reduce a frame effect. Here, the “frame effect” means the following phenomenon. When a stereoscopic image is present beyond the outer edge of the display surface of the three-dimensional display device, specifically when the stereoscopic image is present across the inside and the outside of the display area of the display device, the stereoscopic image discontinuously disappears at the outer edge of the display area, and gives a sense of discomfort to the observer. In such case, to reduce the sense of discomfort, processing is performed such that the displayed stereoscopic image is gradually getting transparent as approaching the outer edge of the display area, and finally becomes completely transparent as reaches the outer edge of the display area.

When performing such image processing, a parameter indicating a distance between the three-dimensional object and the outer edge of the display area is a crucial index. The reason for this is because the transparency of the multi-viewpoint image to be displayed in the display area has to be changed in accordance with the actual distance from the outer edge of the display area. The multi-viewpoint image displayed on the display surface is created by rearranging pixel positions included in each of the viewpoint images with consideration given to the characteristics of the lens array and the color panel of the three-dimensional display device. Therefore, adjacent pixels in the display area when the observer looks at the stereoscopic image (or elements per sub-pixel included in pixels) may not be adjacent to each other in a viewpoint image before rearrangement. Moreover, the adjacent pixels are not necessarily included in the same viewpoint image, but can be included in a plurality of viewpoint images with a scattered manner. For this reason, image processing that is simply performed on each viewpoint image without considering rearrangement of pixel information does not mean an appropriate image processing, thereby possibly degrading the quality of the displayed stereoscopic image.

### DISCLOSURE OF INVENTION

According to one aspect of the present invention, an apparatus for processing a three-dimensional image, the apparatus includes a specified value acquiring unit that acquires characteristics of a stereoscopic display unit as specified parameters, the stereoscopic display unit displaying a multi-viewpoint image that is created by mapping each pixel position included in a plurality of viewpoint images in accordance with the characteristics of the stereoscopic display unit; an observation value acquiring unit that acquires observation parameters indicating observation values of a stereoscopic image displayed on the stereoscopic display unit; a calculating unit that calculates conversion information indicating inverse mapping of the mapping based on the specified parameters; an observation value converting unit that converts observation parameters into converted parameters of the same dimension as the viewpoint images based on the conversion information; and a control unit that controls image processing on a viewpoint image corresponding to each pixel position of the stereoscopic image with respect to each of the viewpoint images based on the converted parameters.

According to another aspect of the present invention, a method for processing a three-dimensional image, the method includes acquiring characteristics of a stereoscopic display unit as specified parameters, the stereoscopic display unit displaying a multi-viewpoint image that is created by mapping each pixel position included in a plurality of viewpoint images in accordance with the characteristics of the stereoscopic display unit; acquiring observation parameters indicating observation values of a stereoscopic image displayed on the stereoscopic display unit; calculating conversion information indicating inverse mapping of the mapping based on the specified parameters; converting observation parameters into converted parameters of the same dimension as the viewpoint images based on the conversion information; and controlling image processing on a viewpoint image corresponding to each pixel position of the stereoscopic image with respect to each of the viewpoint images based on the converted parameters.

A computer program product according to still another aspect of the present invention causes a computer to perform the method according to the present invention.

### BRIEF DESCRIPTION OF DRAWINGS

FIG. 1 is a block diagram of a three-dimensional image processing apparatus according to a first embodiment of the present invention;

FIG. 2 is a functional block diagram of the three-dimensional image processing apparatus;

FIG. 3 is a perspective view of the three-dimensional image display device;

FIG. 4 is a schematic view for explaining relation of pixel positions;

FIG. 5 is a schematic view for explaining relation of pixel positions;

FIG. 6 is a flowchart of operation performed by the image-processing control unit;

FIG. 7 is a schematic view for explaining relation of pixel positions;

FIG. 8 is a functional block diagram of a three-dimensional image processing apparatus according to a second embodiment of the present invention;

FIG. 9 is a flowchart of operation performed by a image-processing control unit; and

FIG. 10 is a functional block diagram of a three-dimensional image processing apparatus according to a third embodiment of the present invention.

### BEST MODE(S) FOR CARRYING OUT THE INVENTION

Exemplary embodiments of the present invention will be explained below in detail with reference to accompanying drawings.

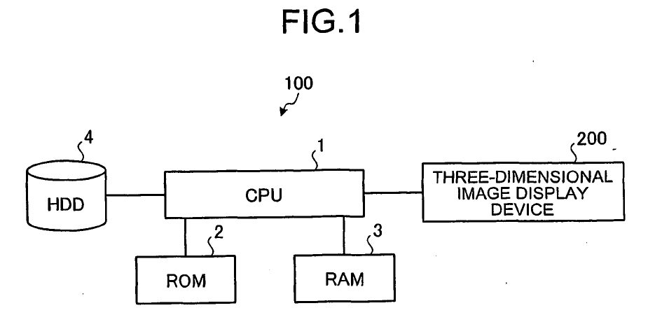

FIG. 1 is a block diagram of a three-dimensional image processing apparatus 100 according to a first embodiment. As shown in FIG. 1, the three-dimensional image processing apparatus 100 includes a central processing unit (CPU) 1 that processes information, a read-only memory (ROM) 2 that stores a basic input-output system (BIOS), a random access memory (RAM) 3 that is a main memory to store various types of data rewritably, and a hard disk (HDD) 4 that stores three-dimensional image contents (viewpoint image group and the like), and a computer program relevant to three-dimensional image processing (hereinafter, “three-dimensional processing program”).

The CPU 1 executes calculations according to the three-dimensional processing program stored in the HDD 4, and totally controls each unit of the three-dimensional image processing apparatus 100. Specifically, the CPU 1 creates a multi-viewpoint image from a viewpoint image group formed of a plurality of viewpoint images stored in the HDD 4, and causes a three-dimensional image display device 200 to display the multi-viewpoint image. Characteristic processing according to the first embodiment to be executed by the CPU 1 in accordance with the three-dimensional processing program is explained below.

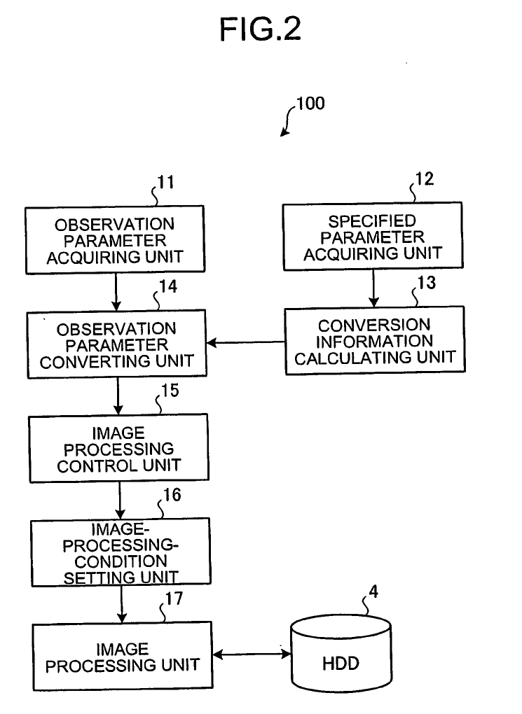

FIG. 2 is a functional block diagram of the three-dimensional image processing apparatus 100. As shown in FIG. 2, the CPU 1 creates an observation parameter acquiring unit 11, a specified parameter acquiring unit 12, a conversion information calculating unit 13, an observation parameter converting unit 14, an image processing control unit 15, an image-processing-condition setting unit 16, and an image processing unit 17 on the main memory by controlling each unit according to the three-dimensional processing program.

The observation parameter acquiring unit 11 acquires various parameters (hereinafter, “observation parameters”) that are observed when a multi-viewpoint image created by the three-dimensional image processing apparatus 100 is displayed as a stereoscopic image by the three-dimensional image display device 200. The observation parameters include, for example, the size and the position of the stereoscopic image displayed on a stereoscopic display unit 230 of the three-dimensional image display device 200, and the size and the position of each of pixels that form the stereoscopic image (for example, a distance between each of the pixels and the outer edge of the stereoscopic display unit 230). The observation parameters are information that can be acquired by observing the stereoscopic image.

The observation parameter acquiring unit 11 can acquire the observation parameters by any method. For example, pre-observed observation parameters can be stored into a storage device such as a nonvolatile memory, and then the observation parameter acquiring unit 11 can acquire the observation parameters from the storage device. In this case, the storage device can be integrated into the three-dimensional image display device 200 that displays the stereoscopic image, and the observation parameter acquiring unit 11 can acquire the observation parameters via the three-dimensional image display device 200 and an interface.

Alternatively, the observation parameter acquiring unit 11 can acquire the observation parameters for the three-dimensional image display device 200 that displays the stereoscopic image from an external database device and the like connected to a network, such as the Internet, via a communication device connectable to the network. Furthermore, the observation parameters can be acquired as input by a user via an input device, such as a keyboard, which is not shown.

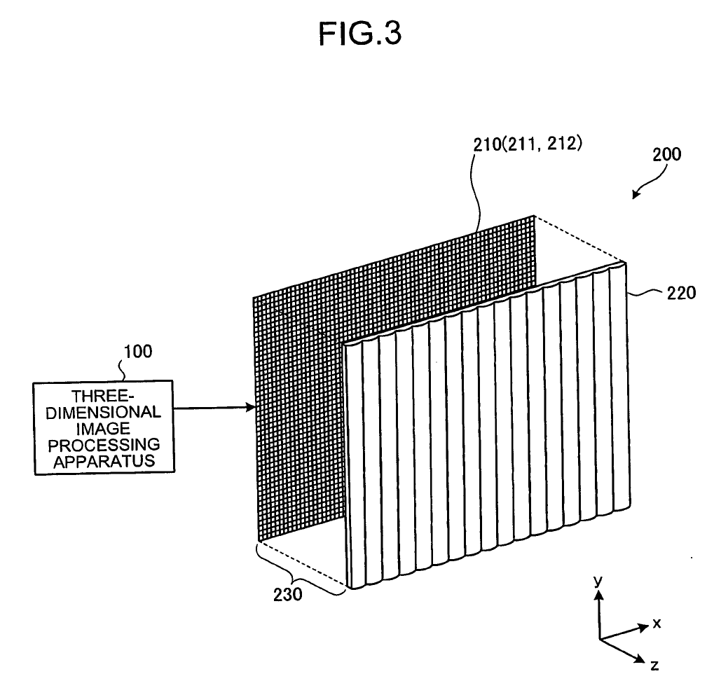

Hereinafter, the three-dimensional image display device 200 will be explained. As shown in FIG. 3, the three-dimensional image display device 200 includes a display screen 210 and a light control element 220. The display screen 210 displays a multi-viewpoint image input from the three-dimensional image processing apparatus 100, which is not shown. The light control element 220, for example, a lenticular sheet, controls light from the display screen 210. The display screen 210 includes image displaying elements 211 of a display device, such as a liquid crystal display (LCD), and a color filter layer 212. Hereinafter, the display screen 210 together with the light control element 220 are referred to as the stereoscopic display unit 230.

The image displaying elements 211 display a multi-viewpoint image input from the three-dimensional image processing apparatus 100. The displayed multi-viewpoint image is observed through the color filter layer 212 and the light control element 220, so that a stereoscopic image corresponding to the multi-viewpoint image is visibly presented to eyes of an observer. In the first embodiment, the three-dimensional image processing apparatus 100 and the three-dimensional image display device 200 are separated. However, the present invention is not limited to this, but the three-dimensional image processing apparatus 100 can be integrated into the three-dimensional image display device 200.

When the three-dimensional image display device 200 displays a stereoscopic image, in practice, light of a multi-viewpoint image (hereinafter, “multi-viewpoint image light”) is displayed in a space on the surface of the stereoscopic display unit 230 (hereinafter, “light space”). When the multi-viewpoint image light is displayed, each pixel position included in the multi-viewpoint image displayed on the image displaying elements 211 and each pixel position of the multi-viewpoint image light displayed in the light space are not in mirror image relation, i.e., not present in the same position. The reason for this is because the color filter layer 212 and the light control element 220 are superposed on the image displaying elements 211 of the three-dimensional image display device 200, and the direction of light emitted from the image displaying elements 211 changes due to characteristics of these members.

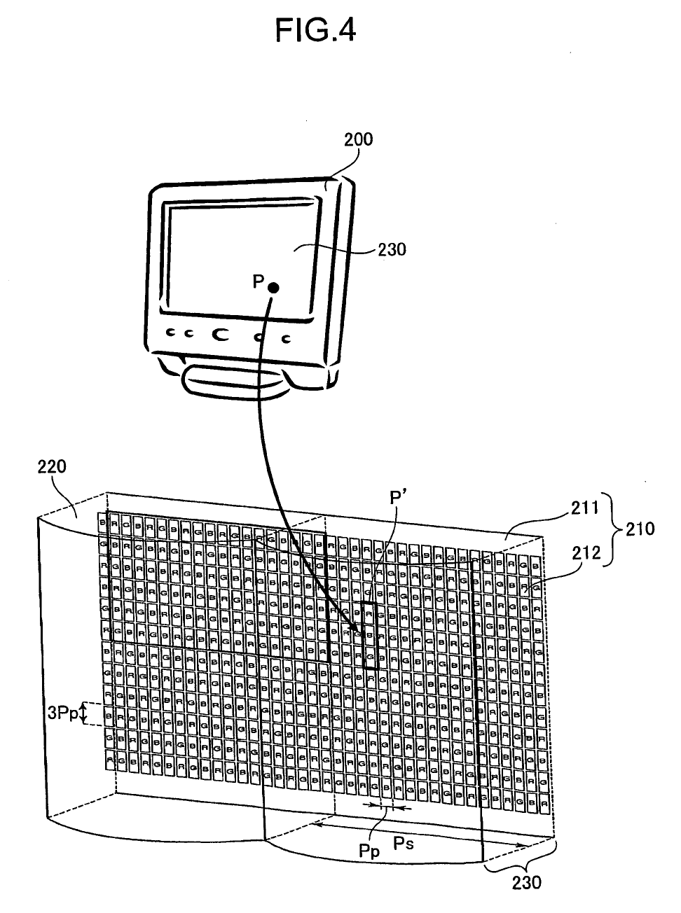

FIG. 4 is a schematic view for explaining relation between a pixel position on the stereoscopic display unit 230 and a pixel position on the display screen 210. In FIG. 4, the color filter layer 212 includes pixels each of which has the aspect ratio of 3 to 1 (3Pp:Pp). The pixels are arranged on transversely and longitudinally straight lines in a matrix on the color filter layer 212. Each of the pixels includes red (R), green (G), and blue (B) that are arranged alternately in the same row in the transverse direction. In addition, each of the pixels is arranged such that R, G, and B appear alternately in the same column in the longitudinal direction. The color filter layer 212 is configured to present one color made of three sub-pixels arranged in the longitudinal direction. A stereoscopic display that gives 18 parallaxes is achieved due to an arrangement that 18 sets of such longitudinally arranged three sub-pixels are arranged transversely in a lens pitch (Ps in FIG. 4).

Suppose a pixel present at a certain position P is observed on the stereoscopic display unit 230, i.e., in the light space. At the moment, a pixel corresponding to the position P on the display screen 210 includes three sub-pixels, for example, longitudinally arranged three sub-pixels present in a region P′. However, relation between a pixel position observed through the light control element 220 and a pixel position on the display screen 210 is not limited to the example shown in FIG. 4.

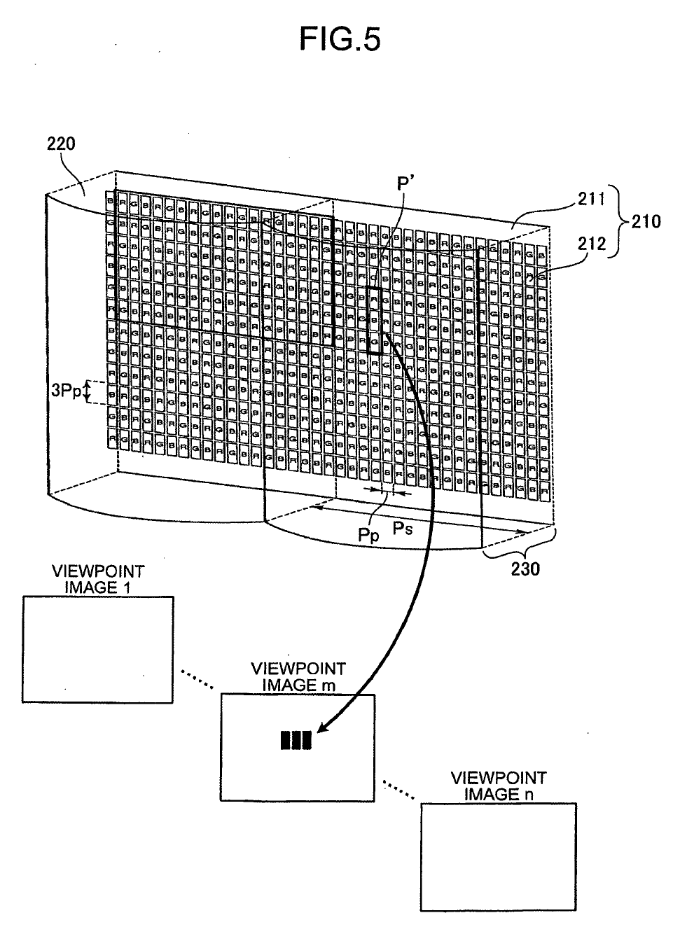

FIG. 5 is a schematic view for explaining relation between a pixel position per sub-pixel on the display screen 210 and a pixel position per sub-pixel in the viewpoint image group. FIG. 5 depicts an example where three sub-pixels present in the region P′ on the display screen 210 are formed of transversely adjoining three pixels in a viewpoint image m within a viewpoint image group composed of n sheets of viewpoint images (m and n are an integer, where m<n). FIG. 5 also depicts a state where the longitudinally arranged three sub-pixels (R, G, and B) on the display screen 210 are converted to the transversely adjoining three sub-pixels in the viewpoint image m.

In this way, mapping from each pixel position per sub-pixel included in a viewpoint image to each pixel position per sub-pixel that forms an image displayed on the display screen 210, i.e., a multi-viewpoint image, is performed under a specific rule determined in accordance with the characteristics of the color filter layer 212 and the light control element 220. Thus, by creating the multi-viewpoint image under the specific rule, a stereoscopic image of the multi-viewpoint image can be provided to the observer.

Arrangement of the color filter layer 212 is not limited to the example shown in FIG. 5. For example, if the color filter layer 212 has an exceptional arrangement, a pixel included in each viewpoint image can be divided into respective RGB elements, and the pixel can be observed on the display screen 210 in a state of a plurality of pixels divided from the original pixel.

Return to FIG. 1, the specified parameter acquiring unit 12 acquires parameters that indicate specifications and characteristics of the stereoscopic display unit 230 (the color filter layer 212, the light control element 220, and the image displaying elements 211), which the three-dimensional image display device 200 includes (hereinafter, “specified parameters”). The specified parameters include, for example, the arrangement of the color filter layer and the longitudinal-transverse size of sub-pixels, the lens pitch and the focal point distance of the light control element 220, and the size and the resolution of the image displaying elements 211, which mean information that is defined in accordance with such as product specifications.

The specified parameter acquiring unit 12 can acquire the specified parameters by any method. For example, a plurality of specified parameters relevant to each unit of the three-dimensional image display device 200 can be prestored into a storage device such as a nonvolatile memory, and then the specified parameter acquiring unit 12 can acquire relevant specified parameters from the storage device. In this case, the storage device can be integrated into the three-dimensional image display device 200, and the specified parameter acquiring unit 12 can acquire the specified parameters via the three-dimensional image display device 200 and an interface. If the specified parameters themselves are not stored in the storage device, the specified parameter acquiring unit 12 can acquire specifications of each of members that form the three-dimensional image display device 200 (hereinafter, “design data”), and can calculate and acquire specified parameters from the design data by performing arithmetic operation, physical operation, and the like.

Alternatively, the specified parameter acquiring unit 12 can acquire the specified parameters from such as an external database device connected to a network, for example, the Internet, via a communication device connectable to the network. For example, if a manufacturer of the optical members discloses specifications of the optical members on a web site, the specified parameter acquiring unit 12 can search design data via the network, can calculate specified parameters with searched design data, and then can acquire the specified parameters. Moreover, the specified parameter acquiring unit 12 can acquire the specified parameters from design data input by a user via an input device such as a keyboard, which is not shown.

The conversion information calculating unit 13 calculates conversion information indicating inverse mapping that is inverse operation to the mapping used for creating the multi-viewpoint image from the viewpoint image group based on the specified parameters acquired by the specified parameter acquiring unit 12. Principles of operation of the conversion information calculating unit 13 are explained below.

When displaying a stereoscopic image, the three-dimensional image display device 200 by the II system determines the number of parallaxes required to present a stereoscopic image based on the specified parameters acquired by the specified parameter acquiring unit 12, specifically, relation between the configuration of the color filter layer 212 and the lens pitch of the light control element 220. After the number of parallaxes is determined, the total number of viewpoint images constituting the viewpoint image group and an image size of each of the viewpoint images are determined based on the number of parallaxes and the specified parameters. Based on the total number and the size determined in this way, the viewpoint image group are created by shooting with a camera array, or by rendering by CG processing.

Conditions for creating the stereoscopic image to be displayed on an actual display panel are then determined by using the specified parameters that indicate characteristics of the color filter layer 212, the light control element 220, the image displaying elements 211 and the like, which the three-dimensional image display device 200 includes. Specifically, the multi-viewpoint image to be displayed is created by rearranging each sub-pixel of the pixels included in the prepared viewpoint image group in accordance with the specified parameters.

In other words, when the specified parameters of the three-dimensional image display device 200 are determined, mapping for rearrangement (conversion) of pixel positions from the viewpoint image group to the multi-viewpoint image is uniquely determined. Conversely, inverse mapping can be calculated. The inverse mapping is an operation to derive an original pixel position in a viewpoint image in the viewpoint image group from each sub-pixel in the multi-viewpoint image that is finally displayed to present the stereoscopic image on the actual display panel. The conversion information calculating unit 13 calculates conversion information corresponding to the inverse mapping by using the specified parameters acquired by the specified parameter acquiring unit 12.

The observation parameter converting unit 14 converts (inversely maps) the observation parameters acquired by the observation parameter acquiring unit 11 by using the conversion information calculated by the conversion information calculating unit 13. In other words, by converting the observation parameters with the use of the conversion information calculated by the conversion information calculating unit 13, the dimension of the observation parameters (for example, pixel positions included in the stereoscopic image) is converted to the dimension of the viewpoint image group (for example, pixel positions in each of the viewpoint images).

According to the first embodiment, the example of pixel positions when the stereoscopic image is displayed on the display surface is explained, however, the present invention is not limited to this. Generally, when a stereoscopic image is displayed, positions to which a pixel in the stereoscopic image (pixel on curvatures that form a three-dimensional shape, precisely, which is based on a different conception from a two-dimensional pixel, because the stereoscopic image is an image in a three-dimensional space) corresponds in a viewpoint image group can be calculated.

The image processing control unit 15 controls a certain image processing procedure stored in the HDD 4 for each of the viewpoint images, based on the observation parameters converted by the observation parameter converting unit 14 and the specified parameters acquired by the specified parameter acquiring unit 12.

Specifically, the image processing control unit 15 outputs parameters converted by the observation parameter converting unit 14 to the image-processing-condition setting unit 16 with respect to each of viewpoints based on the total number of viewpoints determined in accordance with the specified parameters acquired by the specified parameter acquiring unit 12.

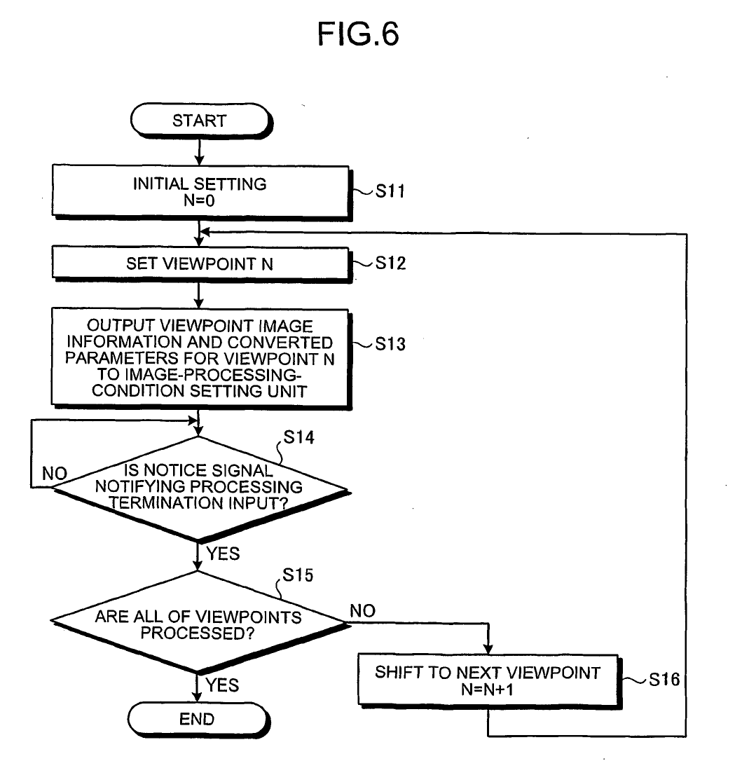

FIG. 6 is a flowchart of operation performed by the image processing control unit 15 according to a first embodiment. To begin with, the image processing control unit 15 performs an initial setting to set a counter N that counts the number of viewpoints to the initial viewpoint, i.e., N=0 (step S11). The image processing control unit 15 then sets a viewpoint image corresponding to the current counter (viewpoint) N from among the total viewpoints determined by the specified parameters on a subject to image processing (step S12).

The image processing control unit 15 then outputs information relating to the viewpoint image of the viewpoint N subjected to image processing and parameters converted by the observation parameter converting unit 14 (hereinafter, “converted parameters”) to the image-processing-condition setting unit 16 (step S13).

Next, the image processing control unit 15 waits a notice signal that notifies the termination of the processing input from the image processing unit 17 (No at step S14). When the notice signal is input (Yes at step S14), the image processing control unit 15 shifts to processing at step S15.

At the step S15, the image processing control unit 15 determines whether all of the viewpoints as many as determined with the specified parameters are processed through steps S12 to S14. If it is determined that the processing is not finished with respect to all of the viewpoints (No at step S15), the image processing control unit 15 increments the counter N by “1” to shift to the next viewpoint (step S16), and then goes back to step S12.

On the other hand, if it is determined that the processing is finished with respect to all of the viewpoints (Yes at step S15), the processing is terminated.

Return to FIG. 1, the image-processing-condition setting unit 16 sets processing conditions for image processing to be performed by the image processing unit 17 (hereinafter, “image processing conditions”), based on information input from the image processing control unit 15. Specifically, the image-processing-condition setting unit 16 receives information relating to viewpoint images subjected to the processing and converted parameters, and then based on such information, sets image processing conditions to be applied to respective pixels included in the viewpoint images subjected to the processing.

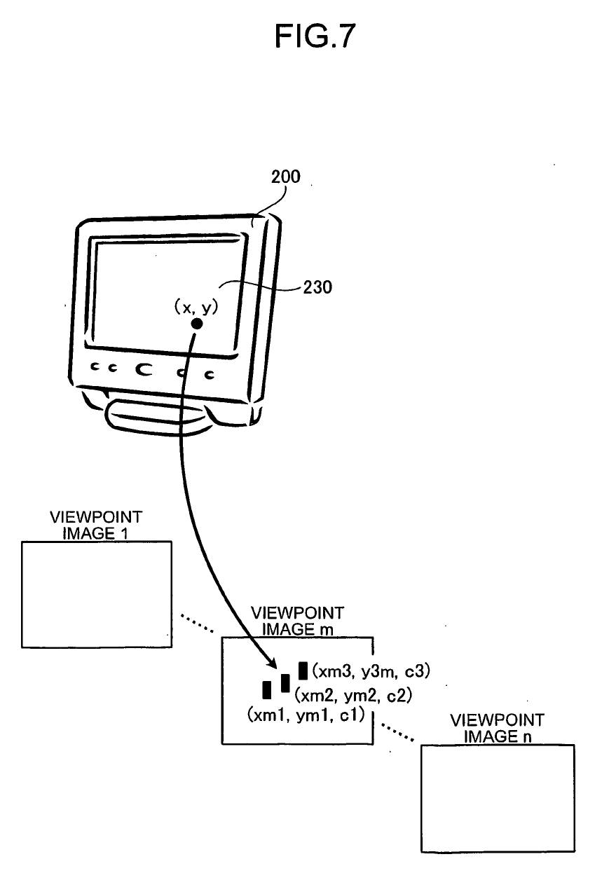

As an example of processing performed by the image-processing-condition setting unit 16, a case of image processing to be performed for reducing the frame effect is explained with reference to FIG. 7. FIG. 7 depicts relation between a pixel position on the stereoscopic display unit 230 and pixel positions of sub-pixels in the viewpoint image group. Here, (x, y) denotes a pixel position of a stereoscopic image on the stereoscopic display unit 230 observed by the observer. In addition, (xm1, ym1, c1), (xm2, ym2, c2), and (xm3, ym3, c3) denote pixel positions into which the pixel position (x, y) is converted by the observation parameter converting unit 14. Moreover, xm1, ym2, and the like mean x-y coordinates at a viewpoint image m, while c1, c2, and c3 mean respective sub-pixels at the coordinates. For example, if a viewpoint image is expressed with RGB 24 bit, there are three sub-pixels, namely, R: 8 bit, G: 8 bit, and B: 8 bit, and c1, c2, and c3 corresponds to the sub-pixels respectively. In other words, (xm1, ym1, c1) denotes the sub-pixel c1 included in a pixel at coordinates (xm1, ym1) in the viewpoint image m.

To simplify explanation, a pixel position on the stereoscopic display unit 230 is converted into sub-pixels in the same viewpoint image m in the example as explained above, however, the present invention is not limited to this. Generally, a pixel position (x, y) displayed on the stereoscopic display unit 230 in the three-dimensional image display device 200 can be converted (inversely mapped) by the observation parameter converting unit 14 into (xm1, ym1, c1), (xn2, yn2, c2), and (x13, y13, c3), in respective different viewpoint images m, n, and l.

During the inverse mapping, to reduce the frame effect, image processing that changes transparency in accordance with a distance from the outer edge of the display area of the stereoscopic display unit 230 is performed. A procedure required for the image processing is expressed in an equation, for example, Equation (1) as follows:

$$d = dist ( x , y ) \\ α = \{ \begin{matrix}A \times d ( where d \leq B ) \\ 1.0 ( where d > B )\end{matrix} \qquad ( 1 )$$

where dist(x, y) is a function that obtains a distance between a pixel present at coordinates (x, y) and the outer edge of the display area (or a distance from the edge of an image displayed on the stereoscopic display unit 230). “A” and “B” are a constant determined as desired, respectively. Based on the value of transparency “a” obtained from these values, the transparency of pixels included in each of the viewpoint images is changed. When a is “0”, the pixel is completely transparent, while it is “1”, the pixel is completely opaque. When a is other than “0” or “1”, and where the color of the pixel at coordinate (x, y) is “c”, converted “c′” is expressed as c′=a×c+(1−a)×c0, where c0 is a background color.

As described above, the pixel coordinates (x, y) of a pixel observed in the stereoscopic display unit 230 is expressed with three sub-pixels, namely, (xm1, ym1, c1), (xm2, ym2, c2), and (xm3, ym3, c3), in a viewpoint image. In this case, respective distances between the coordinates in the viewpoint image and the outer edge of the display area are obtained with dist(xm1, ym1), dist(xm2, ym2), and dist(xm3, ym3), respectively. However, because the pixel positions of the three sub-pixels in the viewpoint image corresponding to a single pixel in the stereoscopic display unit 230 are different, if the image processing is performed based on distances with respect to the different positions, respective values of the transparencies of the three pixels differ from each other.

For this reason, the image-processing-condition setting unit 16 calculates transparency a of each pixel in the viewpoint image according to Equation (1) by using distance d, which is a distance between the outer edge of the display area and the three pixels in the viewpoint image corresponding to the single pixel displayed on the stereoscopic display unit 230, and which is a value converted by the observation parameter converting unit 14 from a distance between the single pixel on the stereoscopic display unit 230 and the outer edge of the display area, obtained as an observation parameters.

Thus, the image-processing-condition setting unit 16 outputs image processing conditions for each of the sub-pixels (for example, convolution at the sub-pixel level, filtering, and the like) created (calculated) through the above process to the image processing unit 17.

In the first embodiment, the transparency processing that intends to reduce the frame effect is explained as an example of image processing, however, the present invention is not limited to this. Other image processing, for example, noise reduction filtering, or low-pass filtering, can be performed similarly.

Furthermore, in the first embodiment, the example where image processing is performed individually on each pixel or each sub-pixel is explained, however, the present invention is not limited to this. For example, when using information of pixels around a specific pixel, the image processing is performed similarly. However, in such case, processing needs to be performed with respect to each sub-pixel. Furthermore, because two adjacent pixels observed in stereoscopic display unit 230 are not necessarily converted into the same viewpoint image, the image processing can use information of sub-pixels present in a plurality of viewpoint images.

The image processing unit 17 performs a certain image processing on a viewpoint image subjected to processing with respect to each pixel included in the viewpoint image based on the image processing conditions set by the image-processing-condition setting unit 16.

Specifically, the image processing unit 17 acquires the viewpoint image subjected to the processing from the HDD 4 based on information relevant to the viewpoint image input from the image processing control unit 15 or the image-processing-condition setting unit 16. The image processing unit 17 performs a certain image processing on the acquired viewpoint image with respect to each pixel included in the viewpoint image based on the image processing conditions set by the image-processing-condition setting unit 16. After the processing is finished, the image processing unit 17 overwrites an image-processed viewpoint image onto the HDD 4, and outputs a signal to notify termination of the processing to the image processing control unit 15.

As described above, according to the first embodiment, observation parameters indicating observation values relevant to a stereoscopic image can be converted into converted parameters of the same dimension as the viewpoint images, and then based on the converted observation parameters and the specified parameters, image processing onto each of the viewpoint images can be controlled. Therefore, an appropriate image processing can be performed for the stereoscopic image, so that the quality of the stereoscopic image displayed on the stereoscopic display unit can be improved.

According to the first embodiment, the flow of the image processing is explained by focusing on a specific viewpoint image, however, the image processing is similarly performed on all of the viewpoint images. Furthermore, when the observer changes the position from which the observer observes the three-dimensional image display device, or when a plurality of observers observe it, positions (viewpoints) from which the observer(s) observe are different, so that the image processing is similarly performed with respect to each viewpoint for observing. In other words, the image processing is similarly performed with respect to all parallax directions that the three-dimensional image display device provides, i.e., all of the viewpoint images.

Next, a three-dimensional image processing apparatus according to a second embodiment is explained below. Each component similar to that of the first embodiment is assigned with the same reference numeral, and explanation for it is omitted.

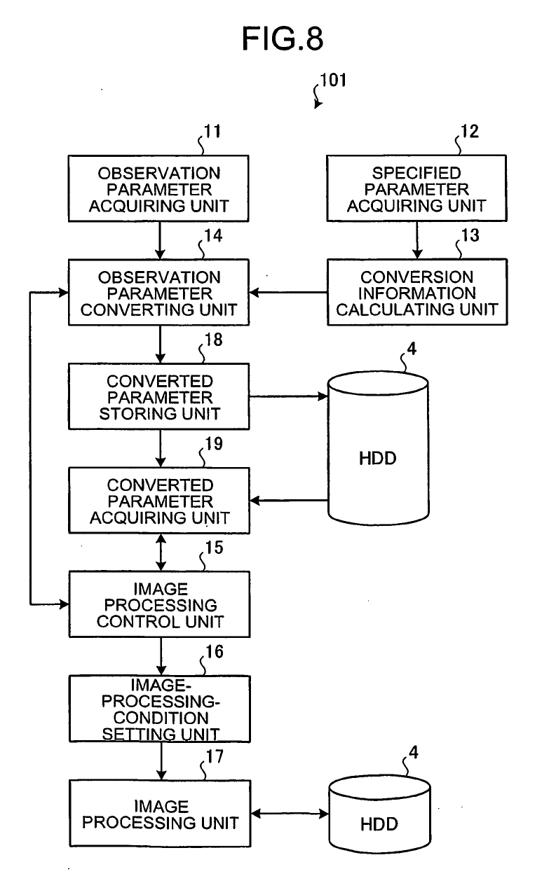

FIG. 8 is a functional block diagram of a three-dimensional image processing apparatus 101 according to the second embodiment. In the three-dimensional image processing apparatus 101 shown in FIG. 8, the CPU 1 creates the observation parameter acquiring unit 11, the specified parameter acquiring unit 12, the conversion information calculating unit 13, the observation parameter converting unit 14, the image processing control unit 15, the image-processing-condition setting unit 16, the image processing unit 17, a converted parameter storing unit 18, and a converted parameter acquiring unit 19 on the main memory by controlling each unit according to the three-dimensional processing program.

In response to a request signal input from the image processing control unit 15, the observation parameter converting unit 14 according to the second embodiment converts observation parameters relevant to the request signal based on conversion information, and outputs converted observation parameters to the image processing control unit 15.

The converted parameter storing unit 18 stores the converted observation parameters converted by the observation parameter converting unit 14 (hereinafter, “converted parameters”) into a certain storage area in the HDD 4. In the second embodiment, the converted parameters are stored into the HDD 4, however, the present invention is not limited to this. For example, the converted parameters can be stored into the RAM 3, which is a temporary storage area. Furthermore, the converted parameters can be stored into a computer connected to a network such as the Internet.

In response to the request signal input from the image processing control unit 15, the converted parameter acquiring unit 19 acquires the converted parameters instructed with the request signal from the HDD 4, and outputs acquired converted parameters to the image processing control unit 15. If the converted parameter acquiring unit 19 cannot acquire the converted parameters instructed by the image processing control unit 15 from the HDD 4, precisely, if the image processing control unit 15 requests converted parameters that are not converted by the observation parameter converting unit 14, the converted parameter acquiring unit 19 outputs an instruction signal indicating that requested converted parameters are unavailable to acquire to the image processing control unit 15.

The image processing control unit 15 according to the second embodiment receives converted parameters from the converted parameter acquiring unit 19 or the observation parameter converting unit 14, and controls the image-processing-condition setting unit 16 and the image processing unit 17 similarly to the first embodiment.

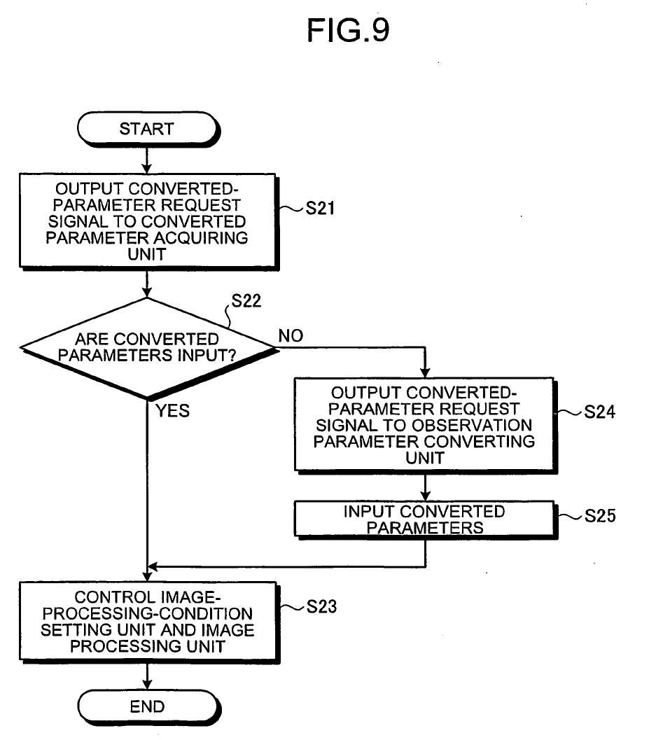

FIG. 9 is a flowchart of operation performed by the image processing control unit 15 according to the second embodiment. To begin with, the image processing control unit 15 outputs a request signal that requests converted parameters relevant to image processing to be performed by the image-processing-condition setting unit 16 and the image processing unit 17 to the converted parameter acquiring unit 19 (step S21).

The image processing control unit 15 then determines whether the converted parameters are input from the converted parameter acquiring unit 19 (step S22). If the converted parameters are input (Yes at step S22), the image processing control unit 15 controls the image-processing-condition setting unit 16 and the image processing unit 17 based on the converted parameters similarly to the first embodiment (step S23), and then terminates the processing.

On the other hand, if an instruction signal indicating unavailability of acquiring the converted parameters is input (No at step S22), the image processing control unit 15 outputs a request signal that requests converted parameters to the observation parameter converting unit 14 (step S24). When the converted parameters are input from the observation parameter converting unit 14 (step S25), the image processing control unit 15 then shifts to step S23, controls the image-processing-condition setting unit 16 and the image processing unit 17 similarly to the first embodiment, and then terminates the processing.

As described above, according to the second embodiment, the three-dimensional image processing apparatus can convert the observation parameters indicating observation values relating to the stereoscopic image into converted parameters of the same dimension as the viewpoint images, and can control specific image processing on each of the viewpoint images based on the converted observation parameters and the specified parameters. Consequently, the three-dimensional image processing apparatus can perform an appropriate image processing on the stereoscopic image, thereby improving the quality of the stereoscopic image displayed on the stereoscopic display unit. Moreover, because the three-dimensional image processing apparatus can reuse stored converted parameters, redundant calculation can be omitted, so that processing speed can be improved.

In the second embodiment, if the image processing control unit 15 requests converted parameters that the observation parameter converting unit 14 does not convert, the converted parameter acquiring unit 19 outputs the instruction signal indicating the unavailability of acquiring the requested converted parameters to the image processing control unit 15. However, the present invention is not limited to this. For example, the converted parameter storing unit 18 can retry to request the converted parameters requested by the image processing control unit 15 to the observation parameter converting unit 14.

Next, a three-dimensional image processing apparatus according to a third embodiment is explained below. Each component similar to that of the first embodiment is assigned with the same reference numeral, and explanation for it is omitted.

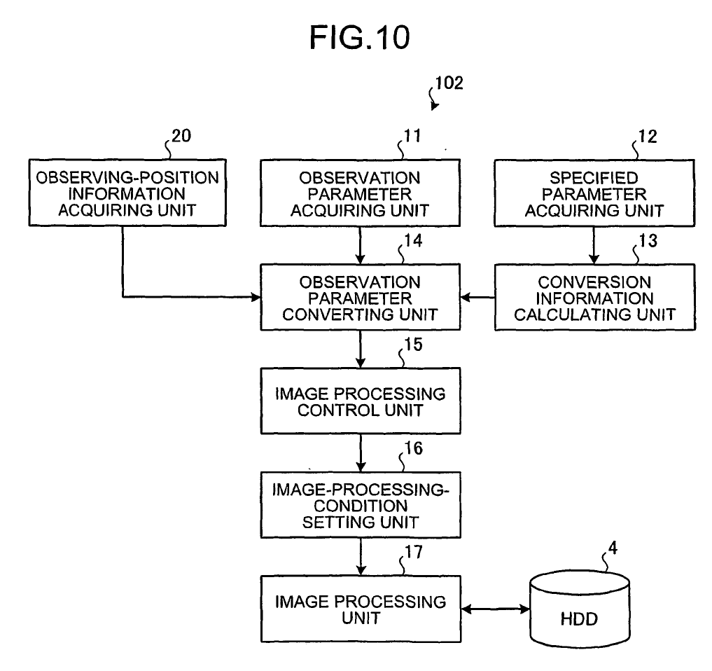

FIG. 10 is a functional block diagram of a three-dimensional image processing apparatus 102 according to the third embodiment. In the three-dimensional image processing apparatus 102 shown in FIG. 10, the CPU 1 creates the observation parameter acquiring unit 11, the specified parameter acquiring unit 12, the conversion information calculating unit 13, the observation parameter converting unit 14, the image processing control unit 15, the image-processing-condition setting unit 16, the image processing unit 17, and an observing-position information acquiring unit 20 on the main memory by controlling each unit according to the three-dimensional processing program.

The observing-position information acquiring unit 20 acquires observing-position information that indicates an observing position of an observer who observes the three-dimensional image display device 200 (stereoscopic display unit 230). The observing-position information is information that indicates relative or absolute positional relation between the three-dimensional image display device 200 and the observer of the three-dimensional image display device 200. For example, the observing-position information includes the presence position of the observer, a direction of the observer's body (for example, direction of sight line), and a distance between the observer and the three-dimensional image display device 200.

In this case, the observing-position information acquiring unit 20 can use any method to acquire the observing-position information. For example, a position of the observer's head or eyes is detected by using a head tracking system or an eye tracking system, and then the observing-position information acquiring unit 20 can acquire positional relation between the observer and the three-dimensional image display device 200 from the detection result as observing-position information. Alternatively, the observer is shot, such as by a camera, and then the observing-position information acquiring unit 20 can acquire observing-position information by analyzing the shot image with a known computer vision technology. In another case, the observer is required to wear a transmitter, and the observing-position information acquiring unit 20 can acquire observing-position information by detecting a signal transmitted from the transmitter. It is assumed that the position where the three-dimensional image display device 200 is present is detected in advance.

The observation parameter converting unit 14 according to the third embodiment converts observation parameters acquired by the observation parameter acquiring unit 11 based on conversion information calculated by the conversion information calculating unit 13 and observing-position information acquired by the observing-position information acquiring unit 20. Principles of operation of the observation parameter converting unit 14 are explained below.

A positional relation between the observer and the three-dimensional image display device 200 can be detected from the observing-position information acquired by the observing-position information acquiring unit 20. An improvement in the quality of the stereoscopic image can be expected by limiting displaying the stereoscopic image in the direction where the observer is present instead of all directions around the three-dimensional image display device 200. The reason for this is because the stereoscopic image can be biased, specifically, light flux in the light space in which the stereoscopic image is displayed can be biased, to the direction where the observer is present. Due to this, a display intensity of the stereoscopic image displayed on the stereoscopic display unit 230 can be made high (high resolution).

When the observer biases the intensity of the light space in accordance with the observing position as described above, the observer needs to derive new converting information corresponding to the observing position in addition to the characteristics of the three-dimensional image display device 200 (the stereoscopic display unit 230). The observation parameter converting unit 14 according to the third embodiment calculates mapping for distorting the light space in which the stereoscopic image is formed based on the observing-position information (generally, mapping can be performed one to many, or many to one, in addition to one to one). The observation parameter converting unit 14 then calculates new conversion information by adding conversion information calculated by the conversion information calculating unit 13 to the mapping. The observation parameter converting unit 14 then converts observation parameters acquired by the observation parameter acquiring unit 11 by using the new conversion information.

Specifically, the observation parameter converting unit 14 calculates a vector V (direction of the observer presence from the three-dimensional image display device 200) that is obtained from relative positional relation between the observer and the three-dimensional image display device 200 based on the observing-position information acquired by the observing-position information acquiring unit 20. In the conversion information calculated by the conversion information calculating unit 13, light flux in the light space in which the stereoscopic image is displayed is defined so as to be arranged uniformly to the stereoscopic display unit 230, because of a request that the range of view (area where the stereoscopic image can be seen) should be taken widely.

In addition, the observation parameter converting unit 14 specifies pixel positions on the multi-viewpoint image (viewpoint images) corresponding to light flux in a direction substantially similar to the vector V, among light fluxes of the multi-viewpoint image illuminated from the stereoscopic display unit 230 that form the light space, based on the conversion information calculated by the conversion information calculating unit 13. The observation parameter converting unit 14 then calculates new conversion information to map pixel positions of the stereoscopic image onto the specified pixel positions (hereinafter, “observing position conversion information”), and converts the observation parameters acquired by the observation parameter acquiring unit 11 based on the observing position conversion information.

The flux substantially similar direction to the vector V can be determined through the following process. For example, where a traveling direction of flux illuminated from the stereoscopic display unit 230 is denoted as a vector W, an angle θ that the vector V and the vector W form is calculated by using an inner product between the vector V and the vector W (V·W=|V|·|W|cos θ), and if the value of θ is smaller than a threshold value, the flux is determined as substantially similar. However, the present invention is not limited to this method.

When a plurality of fluxes in the direction substantially similar to that of the vector V is obtained according to the above method, in order to display a stereoscopic image with the fluxes, mapping for connecting each pixel position included in each of the viewpoint images to each pixel position included in the stereoscopic image can be calculated by using the observation parameters acquired by the observation parameter acquiring unit 11. Here, an inverse mapping to the calculated mapping is equivalent to observing position conversion information.

As described above, according to the third embodiment, image processing can be performed in accordance with the observing direction of the observer, so that the quality of a stereoscopic image that is observed from the observing position can be improved.

The mapping for connecting each pixel position included in each of the viewpoint images to each pixel position included in the stereoscopic image can be calculated in advance, otherwise it can be calculated every time as required.

Any display intensity of the stereoscopic image displayed with the fluxes in the direction substantially similar to that of the vector V is acceptable. For example, the display intensity can be defined with observing position conversion information such that the display intensity is uniform. Moreover, the display intensity can be defined with observing position conversion information such that the display intensity is decreased in proportion as the angle θ formed of the vector V and the vector W increases.

The image processing control unit 15 can control such that image processing is performed only on pixels relevant to the observing position of the observer in the viewpoint image group. Due to this, image processing can be omitted in part that does not affect the observing direction of the observer, so that the speed of the processing can be improved.

Furthermore, according to the third embodiment, the observing position conversion information is calculated by the observation parameter converting unit 14, however, the present invention is not limited to this. For example, the observing-position information acquired by the observing-position information acquiring unit 20 is input into the conversion information calculating unit 13, and the conversion information calculating unit 13 can calculate the observing position conversion information. In this case, the observation parameter converting unit 14 converts observation parameters based on the observing position conversion information calculated by the conversion information calculating unit 13.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An apparatus for processing a three-dimensional image, the apparatus comprising:
a specified value acquiring unit that acquires characteristics of a stereoscopic display unit as specified parameters, the stereoscopic display unit displaying a multi-viewpoint image that is created by mapping each pixel position included in a plurality of viewpoint images in accordance with the characteristics of the stereoscopic display unit;
an observation value acquiring unit that acquires observation parameters indicating observation values of a stereoscopic image displayed on the stereoscopic display unit;
a calculating unit that calculates conversion information indicating inverse mapping of the mapping based on the specified parameters;
an observation value converting unit that converts the observation parameters into converted parameters of the same dimension as the viewpoint images based on the conversion information; and
a control unit that controls image processing on a viewpoint image corresponding to each pixel position of the stereoscopic image with respect to each of the viewpoint images based on the converted parameters.

2. The apparatus according to claim 1, further comprising:
a storage unit that stores converted parameters converted by the observation value converting unit; and
a parameter acquiring unit that acquires the converted parameters stored in the storage unit, wherein
the control unit controls image processing on the viewpoint image corresponding to each pixel position of the stereoscopic image with respect to each of the viewpoint images based on one of the converted parameters converted by the observation value converting unit and the converted parameters acquired by the parameter acquiring unit.

3. The apparatus according to claim 1, further comprising:
a position acquiring unit that acquires observing-position information of an observer who observes the stereoscopic image, wherein
the observation value converting unit converts the observation parameters into values in response to the observing-position information based on the conversion information and the observing-position information, and converts the converted observation parameters into converted parameters of the same dimension as the viewpoint images, and
the control unit controls image processing on the viewpoint image corresponding to each pixel position of the stereoscopic image with respect to each of the viewpoint images based on the converted parameters.

4. The apparatus according to claim 1, further comprising:
a condition setting unit that sets conditions of image processing for each of pixels included in each of the viewpoint images based on a control performed by the control unit; and
an image processing unit that performs image processing on each of pixels included in each of the viewpoint images based on image processing conditions set by the condition setting unit.

5. The apparatus according to claim 1, wherein
the stereoscopic display unit includes image displaying elements for displaying the multi-viewpoint image, a color filter layer superposed on the image displaying elements, and a light control element for controlling light from the image displaying elements, and
the specified parameter acquiring unit acquires characteristics of at least one of the image displaying elements, the color filter layer, and the light control element as specified parameters.

6. The apparatus according to claim 5, wherein the light control element is a lenticular sheet superposed on the image displaying elements.

7. The apparatus according to claim 1, wherein the observation value acquiring unit acquires a position of a stereoscopic image displayed on the stereoscopic display unit.

8. The apparatus according to claim 1, wherein the observation value acquiring unit acquires a distance between a stereoscopic image displayed on the stereoscopic display unit and an outer edge of the stereoscopic display unit.

9. The apparatus according to claim 3, wherein the position acquiring unit acquires positional relation between the stereoscopic display unit and the observer.

10. The apparatus according to claim 3, wherein the position acquiring unit acquires an observing direction of the observer toward the stereoscopic display unit.

11. The apparatus according to claim 3, wherein the position acquiring unit acquires a distance between the stereoscopic display unit and the observer.

12. A method for processing a three-dimensional image, the method comprising:
acquiring characteristics of a stereoscopic display unit as specified parameters, the stereoscopic display unit displaying a multi-viewpoint image that is created by mapping each pixel position included in a plurality of viewpoint images in accordance with the characteristics of the stereoscopic display unit;
acquiring observation parameters indicating observation values of a stereoscopic image displayed on the stereoscopic display unit;
calculating conversion information indicating inverse mapping of the mapping based on the specified parameters;
converting the observation parameters into converted parameters of the same dimension as the viewpoint images based on the conversion information; and
controlling image processing on a viewpoint image corresponding to each pixel position of the stereoscopic image with respect to each of the viewpoint images based on the converted parameters.

13. A computer program product having a computer readable medium including programmed instructions for processing a three-dimensional image, wherein the instructions, when executed by a computer, cause the computer to perform:
acquiring characteristics of a stereoscopic display unit as specified parameters, the stereoscopic display unit displaying a multi-viewpoint image that is created by mapping each pixel position included in a plurality of viewpoint images in accordance with the characteristics of the stereoscopic display unit;
acquiring observation parameters indicating observation values of a stereoscopic image displayed on the stereoscopic display unit;
calculating conversion information indicating inverse mapping of the mapping based on the specified parameters;
converting observation parameters into converted parameters of the same dimension as the viewpoint images based on the conversion information; and
controlling image processing on a viewpoint image corresponding to each pixel position of the stereoscopic image with respect to each of the viewpoint images based on the converted parameters.
